(19) United States
(12) Patent Application Publication
(10) Pub. No.: US 2014/0190134 A1
(43) Pub. Date: Jul. 10, 2014

(54) EXTERNAL LATERAL THORACIC VESSEL PROTECTOR

(71) Applicant: BROOKS EQUINE SOULUTIONS, INC., Aliso Viejo, CA (US)

(72) Inventor: PAUL J BROOKS, ALISO VIEJO, CA (US)

(73) Assignee: BROOKS EQUINE SOULUTIONS, INC., Aliso Viejo, CA (US)

(21) Appl. No.: 13/954,721

(22) Filed: Jul. 30, 2013

Related U.S. Application Data
(60) Provisional application No. 61/751,158, filed on Jan. 10, 2013.

(51) Int. Cl. B68B 7/00

(52) U.S. Cl. CPC B68B 7/00
USPC 54/23

(57) ABSTRACT

A vasculature occlusion protection device is provided for protecting against at least partial occlusion of a superficial vessel of an animal. The devices include a rigid structure having a first face shaped to comfortably conform to the outside of the animal and a second face shaped to accept and retain a portion of the wrap applied to the animal when in use (e.g., a saddle girth). The first face has at least one lateral channel therein, the lateral channel sized and shaped to shield a portion of the superficial vessel from the portion of the wrap retained by the device, the second face configured to permit the portion of the wrap restrained by the device to maintain secure application of the wrap to the animal while the device is in use.

### RELATED APPLICATION

This application claims priority to provisional patent application U.S. Ser. No. 61/751,158 filed on Jan. 10, 2013, the entire contents of which is herein incorporated by reference.

### BACKGROUND

The embodiments herein relate generally to device for protecting superficial vessels from occlusion and, more particularly, to a device suitable for protecting the external lateral thoracic vessel of an equine mammal from occlusion when a saddle strap is tightened about the mammal's abdomen.

Often when saddles are mounted on horses, they are secured with a strap about the abdomen of the horse. In doing so, the strap is tightented to preclude the saddle from sliding laterally while a user is riding the horse. With some horses, the external lateral thoracic vessel, among other parts of the superficial vasculature, are presented close enough to the animal's exterior that the tightened strap has the unintended effect of partially or even possibly fully occluding the vessels. While it may not be immediately noticed, over a short period of time, the horse may be adversely affected by this partial or full occlusion, leaving the horse physically for the worse. In some cases, it may even create chronic medical issues for the horse. Thus, a need exists, and indeed has existed for years, to protect the superficial vasculature, including the external lateral thoracic vessel from partial and/or full occlusion when a saddle is secured to the horse. Embodiments of the present invention address this need.

### SUMMARY

Embodiments of a vasculature occlusion protection device are provided for protecting against at least partial occlusion of a superficial vessel of an animal when a tightly secured wrap is applied to the animal and a portion of that wrap would normally come into contact with the superficial vessel. In one embodiment, the vasculature occlusion protection device comprises a rigid structure configured with a first face to comfortably conform to the outside of the animal and a second face configured to accept and restrain a portion of the wrap applied to the animal when in use. The first face may comprises a generally planar surface having at least one lateral channel therein, where the lateral channel is sized and shaped to shield a portion of the superficial vessel from the portion of the wrap retained by the device embodiment. The first face may also be arcuate in profile to accommodate a more rounded animal anatomy, depending upon where the device is to be placed, or it may be curvilinear, incorporation some generally flat portions and some arcuate portions.

The second face is configured to permit the portion of the wrap restrained by the device to maintain secure application of the wrap to the animal while the device is in use. For example, the second face may be configured to accommodate the strap or girth of a saddle intended for a horse. In some embodiments, the second face preferably includes a ledge for restraining lateral movement of the wrap portion during use; i.e., to retain the wrap portion in place during use.

In some embodiments, the lateral channel is positioned generally perpendicular to a longitudinal axis of the device. In other cases, the lateral channel is positioned at a non-perpendicular angle. Although embodiments described herein are intended for use with the girth of a saddle applicable to a horse, the invention herein includes embodiments intended for other animals to which a tight wrap may be donned, where it is desired to protect against at least partial if not full occlusion of a superficial vessel.

### BRIEF DESCRIPTION OF THE FIGURES

The detailed description of some embodiments of the invention will be made below with reference to the accompanying figures, wherein like numerals represent corresponding parts of the figures.

FIG. 1 is a side view of one embodiment of the invention shown in use;

FIG. 2 is a top perspective view of the embodiment of FIG. 1;

FIG. 3 is a bottom perspective view of the embodiment of FIG. 1;

FIG. 4 is a side view of the embodiment of FIG. 1;

FIG. 5 is a top view of the embodiment of FIG. 1;

FIG. 6 is a front view of the embodiment of FIG. 1;

FIG. 7 is a cross-sectional view taken along line A-A in FIG. 1;

FIG. 8 is a bottom perspective view of a second embodiment of the invention;

FIG. 9 is a top view of the embodiment of FIG. 8;

FIG. 10 is a cross-sectional view taken along line B-B in FIG. 9;

FIG. 11 is a bottom perspective view of a third embodiment of the present invention;

FIG. 12 is a top view of the embodiment of FIG. 11;

FIG. 13 is a cross-sectional view taken along line C-C in FIG. 12.;

### DETAILED DESCRIPTION OF CERTAIN EMBODIMENTS

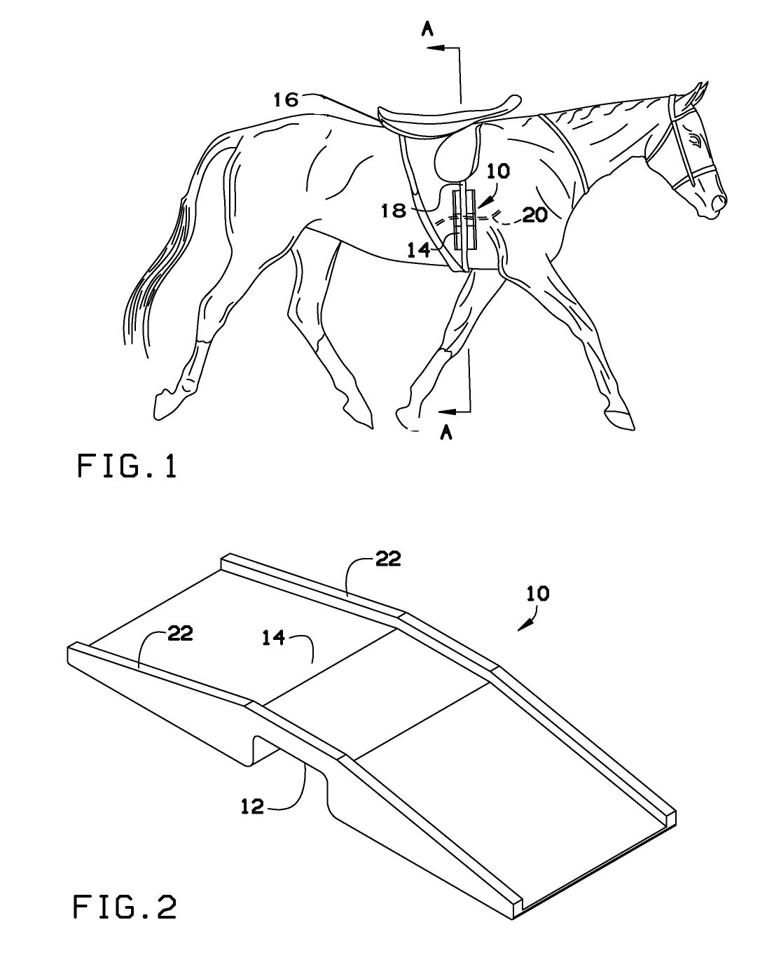

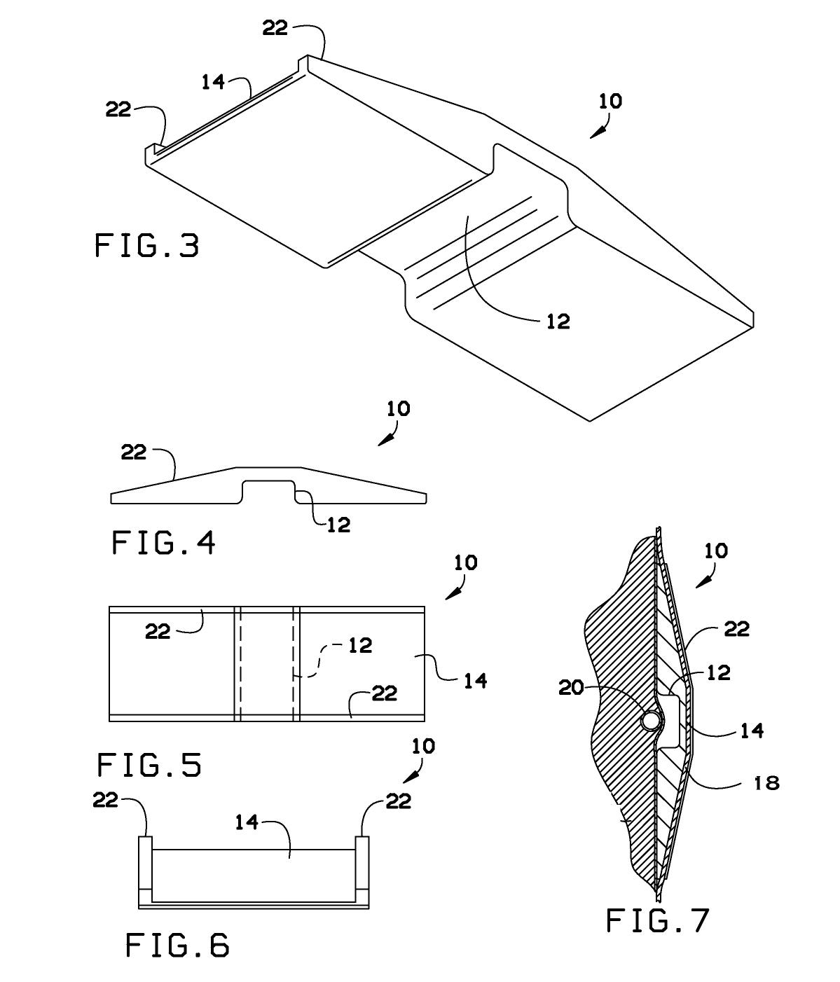

By way of example, and referring to FIGS. 1 through 7, one embodiment of the present system comprises a vasculature occlusion protection device 10 comprising a rigid structure for use with an animal to which a wrap of some form is tightly applied. For example, a saddle 16 may be applied to a horse in which the saddle includes a girth or strap for securing the saddle to the horse. In doing so, the strap must be sufficiently tight to preclude lateral shifting of the saddle during use. Often, the strap must be placed over the abdomen of the horse in such a way that some portion of the superficial vasculature, such as the lateral thoracic artery 20, is covered by the strap, which risks vessel occlusion. The embodiments described herein are configured to minimize if not entirely avoid such occlusion.

In one embodiment of the invention, the device 10 comprises at least one lateral channel 12 in a first surface, and also comprises a second surface 14 configured to permit the strap 18 to be snugly applied to the animal with the device 10 in between the strap 18 and the animal. The second surface 14 preferably comprises ledges 22 to prevent lateral sliding of the strap off of the device while in use.

In some embodiments, such as that shown in FIG. 1, the at least one lateral channel 12 comprises an opening across the first surface with such shape and configuration that space is provided over the superficial vasculature identified by the user for protection, such as the lateral thoracic artery 20, even when the device is tightly strapped to the abdomen of the animal. Such space may be appreciated specifically from the cross-sectional view of FIG. 7, where the device 10 is positioned between the strap 18 and the animal so that the lateral channel 12 covers the lateral thoracic vessel without or with minimal occlusion. As suggested above, more than one lateral channel may be provided where multiple superficial vessels are at issue.

The first surface may be generally flat or slightly curved or even curvilinear as may be desired to accommodate the anatomical profile of various animals to which it is desired to protect occlusion of superficial vasculature. A curved profile is entirely arcuate, although the radii of curvature may vary along the length. A curvilinear profile may combine generally flat portions (i.e., not necessary perfectly flat), with arcuate or curved portions. The second surface may also comprise one of a number of surface configurations that permit tight secure engagement of the strap 18 of the saddle 16, or candidly any other portion of an animal wrap so desired, to the animal. The second surface may comprise a plurality of general flat surface angled with respect to each other, as shown in the embodiments illustrated herein, or may be curved or curvilinear, as with the first surface. The particular surface profile is not critical to effective operation of the embodiments of the present invention.

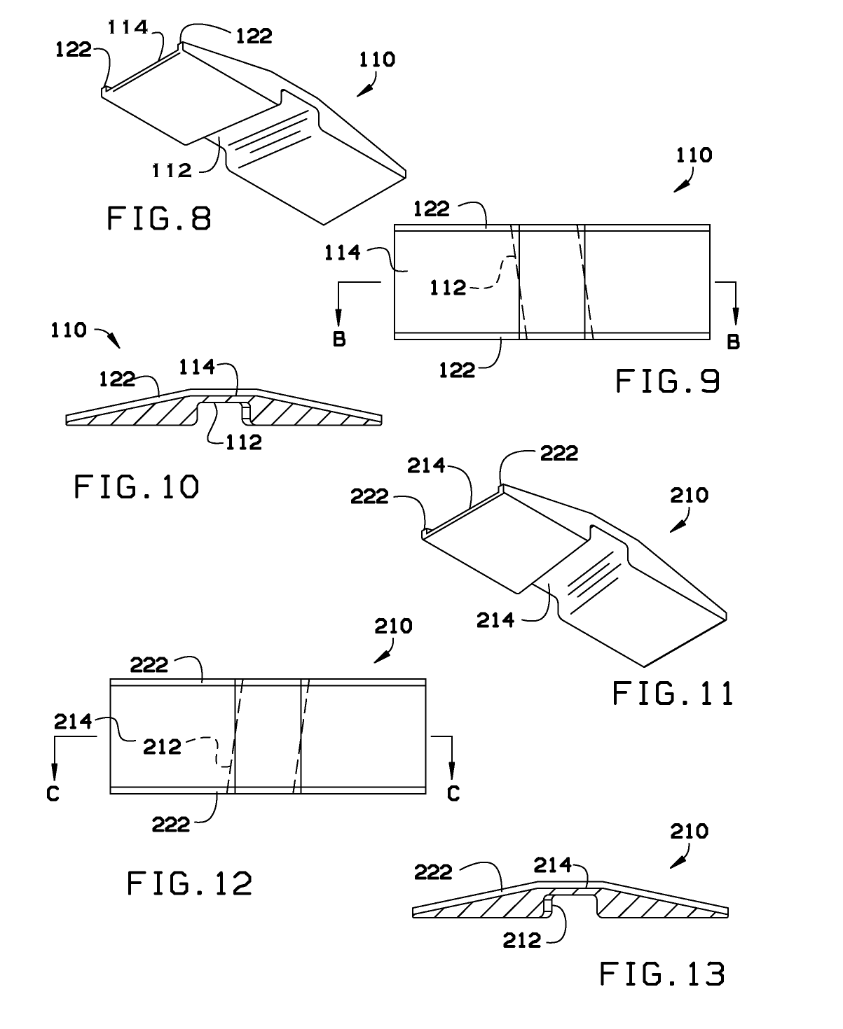

It should be appreciated that the orientation of superficial vessels will vary from animal to animal. In some cases, for example, the lateral thoracic artery will reside generally perpendicular to the orientation of the strap securing the saddle to the horse. In other cases, the vessel may be oriented at an angle. Thus, embodiments of the present invention comprise lateral channels that are not perpendicular to the longitudinal axis to the device. In that regard, referring to FIGS. 8 through 13, two other exemplary embodiments are shown in which the lateral channel 112 or one alternative embodiment 110 is angled in a first direction vis-à-vis the longitudinal axis, while the lateral channel 212 of yet another embodiment 210 is angled in a second direction.

Variations on the internal profile shape of the lateral channel may differ from one embodiment to the next, depending upon the size of the vessel to be protected, the orientation of the vessel to be protected, and how much space is desired between the animal hide covering the vessel and the portion of the animal (e.g., strap for a saddle) covering the hide at that particular spot. It should also be appreciated that embodiments may not require a ledge, or the ledge may be configured differently depending upon the width and/or thickness of the strap of wrap portion that would otherwise come into contact with the superficial vessel.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A vasculature occlusion protection device for protecting against at least partial occlusion of a superficial vessel of an animal when a tightly secured wrap is applied to the animal, the vasculature occlusion protection device comprising a rigid structure configured with a first face to comfortably conform to the outside of the animal and a second face configured to accept and restrain a portion of the wrap applied to the animal when in use, the first face comprising a generally planar surface having at least one lateral channel therein, the lateral channel sized and shaped to shield a portion of the superficial vessel from the portion of the wrap retained by the device, the second face configured to permit the portion of the wrap restrained by the device to maintain secure application of the wrap to the animal while the device is in use, the second face further comprising a ledge for restraining lateral movement of the wrap portion during use.

2. The vasculature occlusion protection device of claim 1, wherein the lateral channel is positioned generally perpendicular to a longitudinal axis of the device.

3. The vasculature occlusion protection device of claim 1, wherein the device is configured for use with a girth of a saddle applicable to a horse.
